(19) United States
(12) Patent Application Publication
(10) Pub. No.: US 2012/0216081 A1
(43) Pub. Date: Aug. 23, 2012

(54) METHOD AND SYSTEM FOR ROOT CAUSE ANALYSIS OF DATA PROBLEMS

(75) Inventors: Vikram Duvvoori, Gilroy, CA (US); Prasad A. Chodavarapu, Bangalore (IN); Ram Mohan, Bangalore (IN)

(73) Assignee: HCL America Inc., Sunnyvale, CA (US)

(21) Appl. No.: 13/029,284

(22) Filed: Feb. 17, 2011

(51) Int. Cl. G06F 11/07

(52) U.S. Cl. 714/48; 714/E11.025

(57) ABSTRACT

A method and system comprising an issue report module to receive a data problem report indicative of the occurrence of a data problem during the performance of a process. The data problem report includes at least one descriptor to identify a problematic data item and may include at least one activity descriptor to identify a particular process activity during which the data problem was encountered. A root cause analysis engine performs automated root cause analysis based on the at least one descriptor of the problematic data item, to identify at least one potential cause of the data problem. The system may include at least one memory having stored thereon data dependency information which comprises, with respect to each of a plurality of entity attributes, information regarding process elements and/or process activities which contribute to the provisioning of data items which are instances of the respective entity attribute, automated root cause analysis being based on the data dependency information. The system may include a data issue repository comprising information regarding earlier data problem reports and respective results of root cause analyses.

### TECHNICAL FIELD

The present application relates generally to analysis of a cause of a data problem during the performance of a process. The application further relates to a method and a system to perform automated root cause analysis of data problems. The application further relates to the filing and processing of missing/bad data incident reports, and the leveraging of a historical store of such incidents.

### BACKGROUND

In processes or process activities which are performed at least in part by computer applications, errors often occur owing to problems with data used in the performance of the process or process activity. Such data issues may be reported in a ticketing system that may assign incidents to particular persons or assignees to fix, also referred to herein as a data problem reporting system. In addition to fixing a particular instance of a data error, which may occasionally cause malperformance of a process activity, an assignee may wish to fix a cause of the data error that gave rise to malperformance of the associated activity, e.g., to fix a root cause of the problem.

### BRIEF DESCRIPTION OF THE DRAWINGS

Some embodiments are illustrated by way of example and not limitation in the figures of the accompanying drawings in which:

FIG. 1 is a schematic block diagram of a system environment for automated root cause analysis, in the example form of a process management system interfaced with an enterprise system, in accordance with an example embodiment.

FIG. 2 is a schematic block diagram of process management application(s) forming part of the example process management system.

FIG. 3 is a schematic diagram of a data structure of process management information according to an example embodiment

FIG. 4 is a high-level schematic diagram of another example system to facilitate automated root cause analysis of data problems.

FIG. 5 is a high-level flow chart of an example method of facilitating automated root cause of data problems.

FIG. 6 is a schematic flow chart illustrating a method of facilitating automated root cause analysis in a structured ticketing system in accordance with an example embodiment.

FIG. 7 is a diagrammatic representation of a machine in the example form of a computer system within which a set of instructions for causing the machine to perform any one or more of the methodologies discussed herein may be executed.

### DETAILED DESCRIPTION

Example methods and systems to perform automated root cause analysis are described. In the following description, for purposes of explanation, numerous specific details are set forth in order to provide a thorough understanding of example embodiments. It will be evident, however, to one skilled in the art that other embodiments may be practiced without these specific details.

According to an example embodiment, there is provided a system and method to perform root cause analysis, using one or more processors, of a data problem or data failure that may occur during the performance of a process.

The system includes at least one memory having stored thereon data dependency information that comprises, with respect to each of a plurality of entity attributes, information regarding process elements and/or process activities which contribute to the provisioning of data items which are instances of the respective entity attribute. In logical data modeling, an “entity” may be considered something of interest to an organization, and may thus be a type of thing being modeled, such as a person or a product. For example, a customer relations management (CRM) application may include the entity of “customer.” An “attribute” of an entity means something that further describes the entity, e.g., customer first name, customer last name, customer telephone number, etc.

A particular instance of an entity attribute, e.g., the name of a particular customer, stored in a memory or datastore during execution of a process, may be referred to herein as a data item. The data dependency information may thus indicate, with respect to at least a specific datastore, information regarding process elements and/or process activities which contribute to population of the specific datastore with data items which are instances of the respective entity attributes.

The system may include an issue report module to receive a data problem report indicative of the occurrence of a data problem or failure during the performance of the process, the data problem comprising unavailability or incorrectness of a problematic data item, and the data problem report including at least one descriptor to identify the problematic data item. The data problem report may also include at least one activity descriptor identifying the particular process activity or activities in which the data problem was encountered. An error which manifests as a process failure or process activity failure (e.g., generation of an invoice or an e-mail with incorrect customer information) may be caused by an underlying data problem (e.g., a problematic data item that is an incorrect customer name entity attribute in a relevant datastore from which the data item is retrieved in the execution of the process activity). The system may include a computer including a root cause analysis engine to perform automated root cause analysis based at least in part on the data dependency information and on at least one descriptor of the problematic data item, to identify at least one potential cause of the data problem. In some embodiments, identification of potential causes of the data problem may comprise identifying the particular process elements and/or process activities that contribute to the provisioning of the problematic data item, as indicated by the data dependency information.

By “process element” is meant any element involved in the performance of an associated process, including IT hardware, IT applications, human resource components, datastores, physical elements, events, and the like. The term “data” as used herein refers to any information items that a process may depend upon or utilize and is to be interpreted broadly as including master data, reference data, transaction data, event data, analytical data, meta-data, text or binary content, and the like.

### Architecture

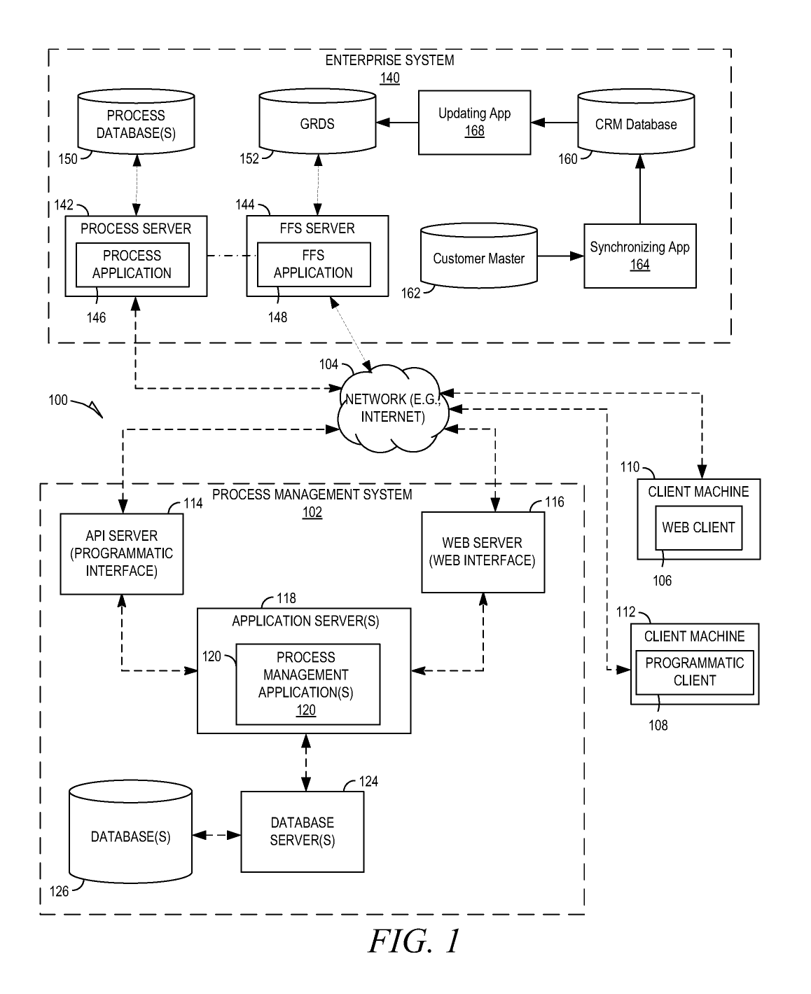

FIG. 1 is a network diagram depicting a client-server system 100, within which one example embodiment may be deployed. A networked process management system 102 provides server-side functionality, via a network 104 (e.g., the Internet, a Wide Area Network (WAN), or a Local Area Network (LAN), to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more process management applications 120. In some examples, process management may be performed with respect to the totality of an organization's activities, in which case the process management system 102 may be an enterprise management system. The application server(s) 118 are, in turn, shown to be coupled to one or more databases server(s) 124 that facilitate access to one or more database(s) 126.

The system 102 is also in communication with a process system or enterprise system 140 which supports a process that is managed by the process management system 102. Some activities of the process which are supported by the enterprise system 140 may be automated or semi-automated activities or processes executed by computers forming part of the enterprise system 140, as explained in further detail below. In some examples, the process management system 102 may provide process modeling functionality to model the process supported by the enterprise system 140, in which case the process management applications 120 may include process model application(s) (e.g., business process models (BPM)). The process management application(s) 120 may be in communication with components of an IT system of the enterprise, in particular being in communication with a number of process servers 142, 144 forming part of the IT infrastructure of the client enterprise system 140. Each of the process servers 142, 144 supports one or more process applications 146, 148, each process application 146, 148 providing functionalities employed in the performance of an associated activity or process supported by the enterprise system 140. It will be appreciated that the enterprise system 140 may typically comprise a greater number of process servers 142 and process databases 150 than those illustrated in FIG. 1, but FIG. 1 shows only a selected number of such process servers 142, 144, for ease of explanation. It is further to be appreciated that communication and interfacing between respective process servers 142, 144 may occur via the network 104, while some of the process servers 142, 144 may be in direct communication.

In the example illustrated with reference to FIG. 1, the process servers include a freight forwarding system (FFS) server 144 on which an FFS application 148 is executed. Such a freight forwarding system tracks each of a number of shipments once it leaves a warehouse until it reaches a final destination. Such a shipment may take a few weeks to months to reach its final destination. During the course of the shipment, it passes through various ports and various kinds of checks. At each of the intermediate nodes, the FFS application 148 is to notify a respective customer (e.g., a sender or recipient of the shipment) with respect to the status and/or progress of the shipment.

Each process server 142, 144 may be in communication with one or more associated database(s) or process datastore(s) 150, 152, to read and/or write associated process data to the respective process databases(s) 150, 152. The FFS server 144, and hence the FFS application 148, may, for example, be in communication with a datastore in the form of a Global Reference Data System (GRDS) 152. Although shown in FIG. 1 as a single database, the GRDS 152 may in practice be comprised of a plurality of dispersed datastores, databases, and/or memories. The GRDS 152 stores reference information such as customers, accounts and locations; for example, the GRDS 152 may contain information about respective accounts established by customers whose shipments are managed by the FFS application 148, and therefore includes a plurality of data items which are attribute values with respect to entities associated with the customers requesting the shipments. Such data items or attribute values may include details about each customer, account, location, etc. In the present example, the GRDS 152 is the single source used by the FFS application 148 with respect to shipment related information. If, for example, the FFS application 148 is to send an e-mail notifying a customer of the progress and/or status of a shipment, the FFS application 148 may, for example, retrieve from the GRDS 152 a data item or attribute value representative of a unique account reference associated with the relevant shipment, may retrieve a data item or attribute value indicating an e-mail address for the corresponding customer(s), and may then send a notification to each appropriate party based upon the retrieved e-mail addresses.

If a retrieved e-mail address in such an example process activity is incorrect, or if the relevant data item is not present in the GRDS 152, then the required notification(s) might not be sent, or might be sent to an incorrect address, which would constitute malperformance of the process activity and would thus result in a process failure. The cause of this example process failure is the absence or incorrectness of the relevant data item or attribute value.

Data may be provided to the GRDS 152 by one or more process activities and/or datastores external to the GRDS 152. Such provisioning of data to the GRDS 152 may, for example, include data transfer, data update, and/or data synchronization between the GRDS 152 and other system database(s) 126 such as, for example, a customer relationship management (CRM) datastore, an accounting datastore, an asset management datastore, a human resources (HR) datastore, and the like. Each of these uploads, transfers, and/or synchronizations may be executed or managed by a respective process application 146. FIG. 1 shows an exemplary sequence of process elements that contribute to provisioning of the GRDS 152 with data items relating to a particular entity attribute. In particular, data items which are attribute values for the entity attribute relating to a customer's e-mail address are shown as being provided from a CRM database 160 by means of an updating application 168. Changes in the CRM database 160 are thus periodically reflected in the GRDS 152 by an update function executed by the updating application 168. The relevant data items, e.g., customer e-mail addresses, are in turn provided to the CRM database 160 from a customer master datastore 162 via a synchronizing application 164. The synchronizing application 164 periodically performs a scheduled synchronizing function to synchronize data items (in this example, customer e-mail addresses) for respective customers in the customer master datastore 162 and the CRM database 160. It will be appreciated that the above-described flow of data items into the GRDS 152 is with respect to data items which are instances of a particular attribute (customer e-mail address) only, and that different process elements may contribute to the provisioning of different data items or attribute values in the GRDS 152.

Some data items may instead, or in addition, be provided to the GRDS 152 by one or more data gathering activities, in which attribute values or data items are entered into the system 140 by manual user input. A data problem with respect to the GRDS 152, such as explained above with respect to the sending of incorrect e-mail notifications, may be caused by non-performance of user input into GRDS 152 at the time of new customer account provisioning, or may be caused by an error in one of the databases 160, 162 which provision the GRDS 152, or may be caused by malperformance or nonperformance of, for example, an updating, transferring, or synchronization activity performed by a respective application 164, 168. A user providing input at, for example the time of new customer account provisioning, also constitutes a “process element” as used herein.

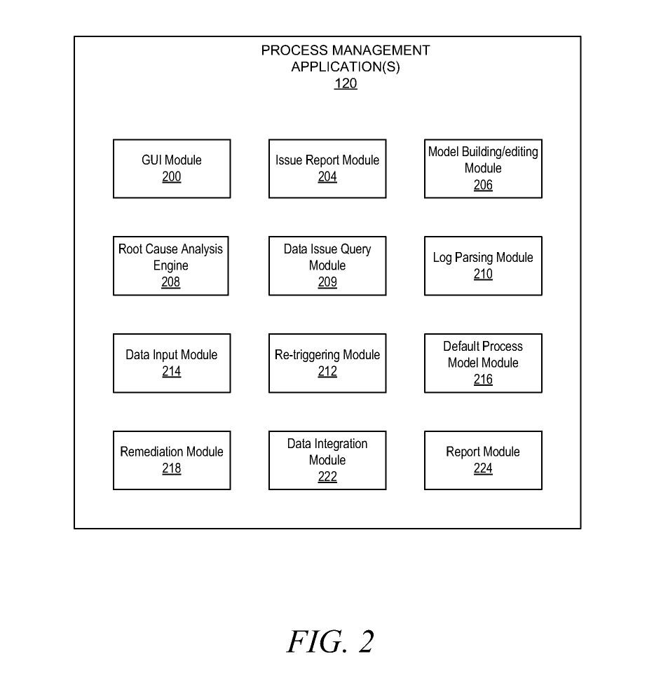

The process management application(s) 120 may provide a number of functions and services to users that access the process management system 102, for example providing analytics, diagnostic, predictive and management functionality relating to system architecture, processes, and activities of the enterprise supported by the enterprise system 140. Respective modules for providing these functionalities are discussed in further detail with reference to FIG. 2 below. In the present description, for clarity of describing mechanisms providing pertinent functionality, the mechanisms will be described in terms of various “modules.” These modules may be implemented in software, firmware or hardware, but the description of different modules does not mean or in any way suggest that the mechanisms that provide the described functionality are separate from one another in any way. For example, the various “modules” might all be implemented in software, through executable instructions stored in a single machine-readable mechanism, with no separation whatsoever as to the functionality provided by the separate instructions. While all of the functional modules, and therefore all of the process management application(s) 120 are shown in FIG. 1 to form part of the process management system 102, it will be appreciated that, in alternative embodiments, some of the functional modules or process model applications may form part of systems that are separate and distinct from the process management system 102.

Further, while the client-server system 100 shown in FIG. 1 employs a client-server architecture, the example embodiments are of course not limited to such an architecture, and could equally well find application in a distributed, or peer-to-peer, architecture system, for example. The process management application(s) 120 could also be implemented as standalone software programs, which do not necessarily have networking capabilities.

The web client 106 accesses the process management application(s) 120 via the web interface supported by the web server 116. Similarly, the programmatic client 108 accesses the various services and functions provided by the process management application(s) 120 via the programmatic interface provided by the API server 114.

### Process Management Application(s)

FIG. 2 is a block diagram illustrating multiple functional modules of the process management application(s) 120 of process management system 102 (FIG. 1). Although the example modules are illustrated as forming part of a single application, it will be appreciated that the modules may be provided by a plurality of applications. The modules of the application(s) 120 may be hosted on dedicated or shared server machines (not shown) that are communicatively coupled to enable communications between server machines. The modules themselves are communicatively coupled (e.g., via appropriate interfaces) to each other and to various data sources, so as to allow information to be passed between the modules or so as to allow the modules to share and access common data. The modules of the application(s) 120 may furthermore access the one or more databases 126 via the database servers 124 (of FIG. 1).

The process management system 102 may therefore provide a number of modules to facilitate automated root cause analysis of the problems or data failures during the performance of a process. The process management application(s) 120 may thus include an incident filing module or issue report module 204 to facilitate the filing and enhancement of data failure reports or data problem reports, also referred to herein as incident tickets. Each data problem report is indicative of the occurrence of a data problem during the performance of a process, such as for example the incorrectness or unavailability of a data item with respect to an e-mail address to be used by the FFS application 148 (FIG. 1). The data problem report may serve to identify a problematic data item associated with the data problem. To this end, the data problem report may include at least one descriptor to identify the problematic data item. The descriptor may include an attribute identifier to indicate an entity attribute of which the problematic data item is an instance. In an example embodiment where the problematic data item is, for example, an incorrect e-mail address, the data problem report may include an attribute identifier such as “customer.email_primary” to indicate that the problematic data item is an incorrect attribute value for the attribute of a primary e-mail address for a customer entity. The data problem report may instead, or in addition, include an entity instance identifier to identify a particular entity instance associated with the problematic data item. The entity instance identifier may thus, for example, indicate that the problematic data item is with respect to “Customer X.” The data problem report may conveniently include both an entity instance identifier and an attribute identifier, to facilitate the identification of a cause of the data problem.

The data problem report may further include a failure type identifier to identify an associated type of data problem and thereby to specify the nature of the problem. The failure type identifier may, for example, indicate: that a data item, such as an attribute value or entity information, is missing; that an attribute value is outdated, or that an attribute value is incorrect. The data problem report may, in the case of an incorrect or outdated attribute value, include a suggested value for the incorrect or outdated data item.

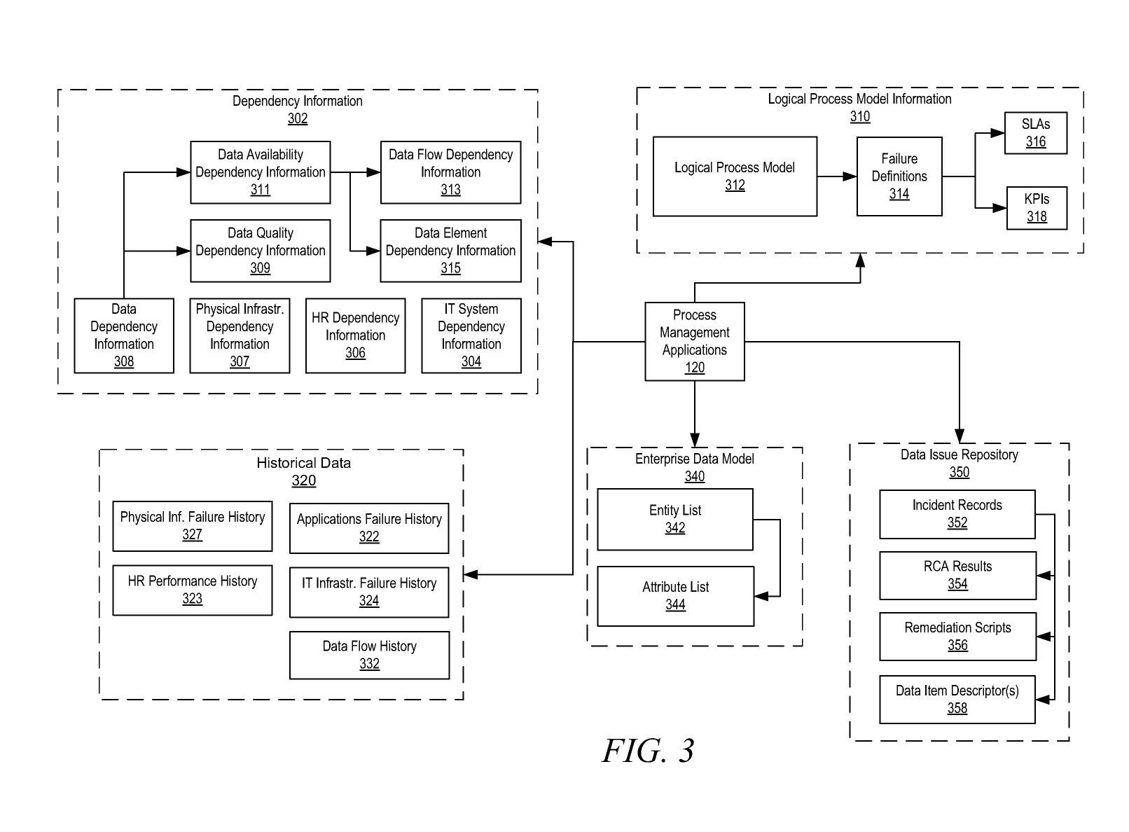

The data problem report may yet further include at least one activity descriptor or activity identifier to identify a particular activity of the process during which the associated data problem occurred or was encountered. The activity descriptor may identify an activity explicitly, for example indicating that the data problem occurred during account generation, shipment notification, or the like. Instead, or in addition, the at least one activity indicator may indicate a particular application that encountered the data problem during its duration, for example identifying the FFS application 148. In a further embodiment, the at least one activity indicator may instead, or in addition, identify a particular employee, employee machine, or location at which the data problem was encountered. In such an embodiment, the system may include information mapping performance of particular activities to corresponding employees, employee machines, and/or locations, and the method may comprise automatically identifying the activity during which the data problem was encountered with reference to such information, based on the employee, employee machine, and/or location indicated in the data problem report. In some embodiments, physical infrastructure dependency information 307, HR dependency information 306 and the IT system dependency information 304 (see FIG. 3 below) may be used for these purposes.

The issue report module 204 may provide a user interface, typically a graphical user interface (GUI), to facilitate the filing of data problem reports. The issue report module 204 may effectively force a user who submits or generates a data problem report or incident ticket to provide information identifying the problematic data item. The data problem report may also include at least one activity descriptor to identify a particular process activity in which the associated data problem occurred or was encountered. To this end, the issue report module 204 may limit the entry of information with respect to the problematic data item to values selected by the user from a predetermined list of options, and/or by requiring the entry of information with respect to at least a minimum number or set of data fields in order for the data problem report to be lodged. In an example embodiment, the GUI provided by the issue report module 204 may include drop-down menus for respective data fields, the user's entry options with respect to such data fields being limited to the options provided in the drop-down menus. The drop-down menus provided with respect to the different data fields may be interrelated and may be dynamically context-sensitive. When, for example, the user selects an entity identifier for a particular entity from a drop-down menu with respect to entity identifiers, a drop-down menu with respect to an attribute identifier may display a list of options limited to the entity corresponding to the selected entity identifier. The issue report module 204 may populate such option lists or drop-down menus based on an enterprise data model (EDM) 340 (see FIG. 3), as is explained in greater detail below. In some embodiments, activity descriptors indicating associated process activities may similarly be chosen from a drop down menu populated with names of processes and their activities, based on relevant information provided by the process management applications 120.

The process management application(s) 120 may further include a root cause analysis engine 208 to perform and/or facilitate automated root cause analysis of data problems or data failures. The root cause analysis engine 208 may perform root cause analysis to identify potential root causes of the data problem represented by the problematic data item identified in the data problem report, based on data dependency information 308 with respect to the relevant process activity managed by process management applications 120, and/or based on information regarding earlier data problem reports in the form of historical incident records 352 stored in a data issue repository 350 (see FIG. 3). The data dependency information 308, as is explained in greater detail below, identifies data availability and data quality dependencies of respective data items, including data flow dependency information 313 that identifies or indicates a set of process elements and/or process activities which contribute to the provisioning of data items with respect to a particular entity attribute, or with respect to a particular entity. The EDM 340 may be a global data model for use by the process management system 102, and may serve as a “dictionary” or universal list of data element types, and the relationships between various data element types, to be used by the system 102. To this end, the EDM 340 may include an entity list 342, which comprises a listing that specifies all the entities that are applicable to processes that are performed by the enterprise system 140. In some embodiments, the EDM 340 may also include a mapping of the relationship between various entities.

The EDM 340 further includes an attribute list 344 in association with the entity list 342. The attribute list 344 provides a set of attributes associated with each of the entities listed in the entity list 342. It will be appreciated that different entities have different associated attributes. For example, the set of attributes which apply to the entity “Customer” will be different from a set of attributes which apply to an entity “Order.” Each entity in the entity list 342 may therefore have a corresponding set of attributes in the attribute list 344.

The data dependency information 308, and in particular the data flow dependency information 313 may be linked to the attribute list 344, thus providing a set or listing of process elements and/or process activities on which provisioning of the corresponding data items are dependent. The data flow dependency information 313 may include not only process elements and/or process activities which contribute directly to the flow or provisioning of the respective entity attribute into an associated datastore, but may also include process activities and/or process elements which contribute indirectly to the availability and/or correctness of the associated entity attribute.

By “process element” is meant any element of the process system, including IT hardware, IT applications, human resource components, datastores, physical elements, events, and the like. The data flow dependency information 313 may thus include a listing of not only hardware components such as databases, servers, software applications, communication links, and the like, that contribute to the flow of data items that are instances of the corresponding attribute in the attribute list 344, but may also include a listing of process activities or events that contribute to the flow of such data items into a specific datastore. With reference to the example embodiment illustrated in FIG. 1, the data flow dependency information 313 with respect to the attribute “email_primary” in relation to the GRDS 152 may, for example, comprise a set of process elements and/or process activities that include the CRM database 160, the customer master datastore 162, the synchronizing application 164, and the updating application 168, as well as a scheduled synchronizing activity performed by the synchronizing application 164, and a scheduled updating activity to be performed by the updating application 168. The particular set of process elements and/or process activities indicated by the data dependency information for respective attributes may vary for each attribute, and may also vary with respect to different datastores. It will be appreciated that different process elements may contribute to the flow of different attributes into a common datastore. Thus, for example, an attribute “customer. account_manager” may be provided to the GRDS 152 via a different data flow path than is the case for the attribute “customer.email_primary.” A different set of process elements may likewise contribute to the flow of data elements which are instances of the attribute “customer.email_primary” into a process database 150 other than the GRDS 152.

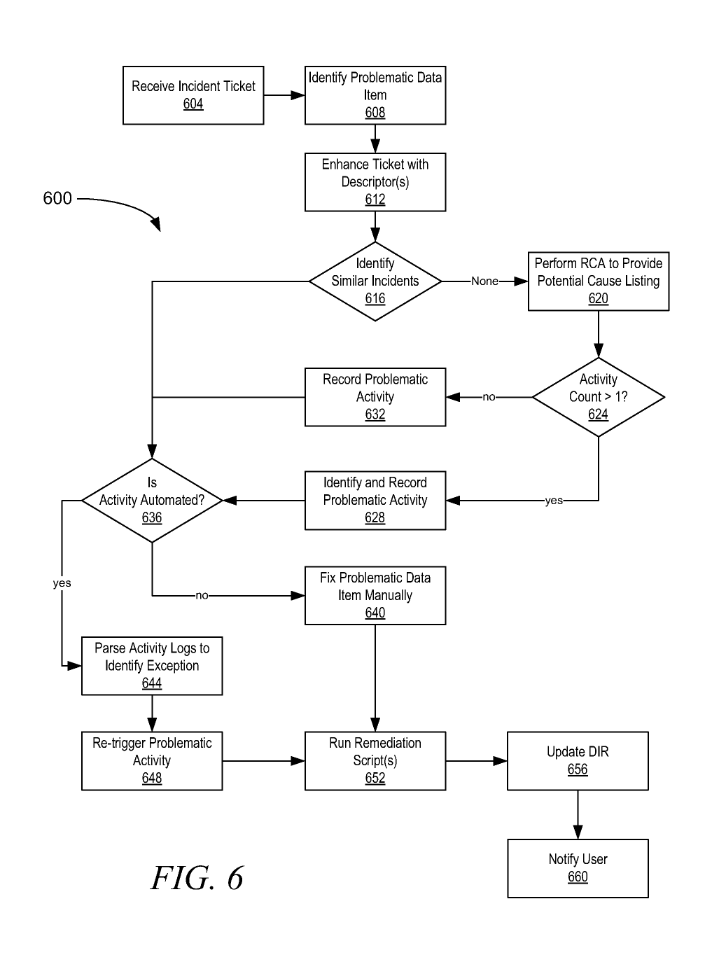

Referring to FIG. 2, the process management application(s) 120 may further include a log parsing module 210 operatively associated with the root cause analysis engine 208, to parse process logs of a process activity identified by the root cause analysis engine 208 as being associated with the problematic data item, in order to identify any exceptions that may have prevented the process activity from executing, or that may indicate a particular instance of the process activity that failed to execute and that may have given rise to the problematic data item. A re-triggering module 212 may be configured to re-trigger a particular process or process activity identified by the log parsing module 210. Such re-triggering may, in some instances, result in providing an absent problematic data item in a corresponding datastore, thereby fixing the problematic data item and preventing a repeat occurrence of the data problem indicated by the data problem report. It is to be noted that the process activities may be specifically designed and implemented such that they can be re-triggered, as will be discussed further with reference to FIG. 6. Likewise, process logs for such activities may also be in a specific format to facilitate or allow parsing of logs, as will also be discussed with reference to FIG. 6.

Referring back to FIG. 2, in one embodiment, the issue report module 204 may store in the data issue repository 350 (of FIG. 3) root cause analysis (RCA) results 354 with respect to historical incident records 352. The incident records 352 in the data issue repository 350 may be associated with data item descriptor(s) 358 pertaining to the respective data problems indicated by the incident records 352. Respective remediation scripts 356 may further be stored in the data issue repository 350 in association with corresponding incident records 352. Such remediation scripts 356 may be scripts in the form of computer-readable code generated or used in resolution of a data problem or the root cause of a data problem, associated with the corresponding incident records 352. Upon receipt of a data problem report, the root cause analysis engine 208 of FIG. 2 may thus query the data issue repository 350 in order to identify similar earlier data problems referenced in the incident records 352.

To this end, the root cause analysis engine 208 may include a data issue query module 209 to interrogate the data issue repository 350. The data issue query module 209 may compare one or more descriptors (such as an entity identifier and/or an attribute identifier) included in the data problem report to the data item descriptors 358, and may identify similar incident record(s) 352 based on similarity between the descriptors of the data problem report and the data item descriptor(s) 358 of the corresponding incident record(s) 352. In response to identifying an incident record 352 matching the data problem report, the data issue query module 209 may provide to the user the RCA results 354 and/or the remediation script 356 corresponding to the matching incident record 352. The issue query module 209 further provides query services functionality that comprises a set of services which provide programmatic access to the EDM 340 and to the data issue repository 350. A user may thus access the EDM 340 and the data issue repository 350 to view, edit, and/or enter data therein.

The process management application(s) 120 may also include a remediation module 218 to retrieve a corresponding remediation script 356 from the data issue repository 350 in the event that the root cause analysis engine 208 identifies an incident record 352 matching the data problem report. The remediation module 218 may in such case execute the remediation script 356 to fix or alleviate the root cause of the data problem.

A GUI module 200 may be configured to provide a management console for the administration of the EDM 340 and the data issue repository 350. A user or administrator may thus add, modify, or delete entities or entity attributes in the EDM 340; create, update, or delete entity-attribute mappings in the EDM 340; and update the data issue repository 350 with previously identified root causes of data problems, together with corresponding remediation scripts. The process management application(s) 120 may administer the EDM 340 and/or the data issue repository 350 in an automated and dynamic fashion to enforce consistency in the EDM 340 in response to the addition, modification, or deletion of EDM entries, so that, for example, deletion of a particular entity from the EDM 340 automatically results in the deletion of entity attributes in the EDM 340 corresponding to the deleted entity. Such automatic and dynamic data management may also be enforced system-wide. For example, relationships between logical process model information 310 and dependency information 302 may automatically be harmonized. Changes to a logical process model 312, to physical infrastructure dependency information 307, to HR dependency information 306, and/or to IT system dependency information 304 may for example automatically result in corresponding changes in data dependency information 308 in general, and the data flow dependency information 313, for example, in particular. These components are described in greater detail below with reference to FIG. 3.

A report module 224 may be provided to generate reports with respect to incidents recorded in the data issue repository 350. Such reports may be generated in response to user requests. The report module 224 may report and analyze incidents logged in the data issue repository 350, thereby assisting an enterprise in identifying underlying process issues that may cause data problems, rather than fixing incidents on an ad hoc basis only. Such reports may also assist in identifying and fixing shortcomings or design flaws in existing processes that may cause data problems.

The system 102 may include process modeling functionality to build and/or edit the process model with respect to a process supported by the enterprise system 140. Process model information with respect to such a process may be used to provide the data dependency information that indicates, with respect to each entity attribute, process elements and/or process activities that contribute to the provisioning of data items. To this end, the application(s) 120 is shown to include at least one default process model module 216 to provide default process models. In instances where the process model is in respect to a business enterprise, the default process model module 216 may provide default business process models (BPM) which are to serve as bases for a user to define a business process model specific to the enterprise system 140. The default BPM's may be predefined by a supplier of the business process management application(s) 120 and are in respect to generic business processes relating to a variety of types of businesses or types of business activities. A user may thus, as a starting point for defining an enterprise-specific BPM, select one or more default process models which most closely approximate the business processes performed by the enterprise system 140. The default process model module 216 may typically provide default logical process models indicating a series of activities, without specific operationalization information indicating particular process elements or support elements on which the activities are dependent. The term “logical process model” refers to the depiction, specification, or mapping of a series of activities of an associated process, excluding process operationalization elements, e.g., IT system components, human resource information, and data dependency information. The term “process” as used herein comprises a series of activities to produce a product or to perform a service, and is to be interpreted broadly as including a process group, a sub-process, or any collection of processes. Therefore, the totality of activities and/or processes which may be performed in an enterprise may also be referred to as a process. In instances where the process model information is therefore with respect to an enterprise, such as a business enterprise, the process model information may thus be in the form of an enterprise model.

A model building/editing module 206 may be provided to enable a user or administrator to define an enterprise-specific process model, either by editing, adapting, or building on a selected default enterprise model, or by building an enterprise model from scratch. The model building/editing module 206 also enables the editing of the enterprise model in response to changes in the enterprise system 140 or the associated processes. As mentioned above, such an enterprise model is a process model which may represent sequences and relationships of business processes, business process activities, as well as relationships of such business process activities to information technology (IT) infrastructure, process applications 146, 148, and process data. The process model information may comprise , at least: a logical process model defining a plurality of activities forming part of the process, the logical process model specifying relationships between the respective activities; IT system dependency information indicative of dependency of respective activities on associated IT system elements, the IT system dependency information including datastore dependency information indicative of one or more datastores which may be accessed in execution of respective activities; and data dependency information indicative of dependency of process activities on data in the one or more datastores which may be accessed in execution of respective activities. As is explained in greater detail below with reference to FIG. 3, the data dependency information may include data flow dependency information and/or data element dependency information.

The process management application(s) 120 may include a data integration module 222 to integrate information with respect to data dependency contained in various databases 126. For example, the data integration module 222 may be configured to integrate the process model information with the EDM 340 and with the data dependency information 308. In one embodiment, the data integration module 222 may automatically compile some aspects of the data dependency information 308 based on relevant related aspects of the data dependency information 308 and the logical process model information 310.

The process management application(s) 120 may further include a data gathering module (not shown) to gather and collate information regarding the performance of respective processes and/or activities. To this end, the data gathering module may cooperate with monitoring applications (not shown) installed in each of the process servers 142, 144 and/or client machines (not shown) forming part of the enterprise system 140. The system 102 may thus gather and record information regarding activities performed by respective elements forming part of the enterprise system 140. A data event such as data synchronization, data collation, or data transfer between two data repositories may be logged or recorded to facilitate tracking or monitoring of performance of the associated business activities, and to facilitate the identification of exceptions in such process logs which may indicate non-performance of a process activity that potentially may give rise to a particular problematic data item or data problem. Further data which may be gathered may include error data generated in response to unscheduled unavailability of applications or infrastructure elements.

### Data Structures

FIG. 3 is an entity-relationship diagram, illustrating various tables, data repositories, or databases that may be maintained within the databases 126 (FIG. 1), and that may be utilized by the process management application(s) 120. The databases 126 also include logical process model information 310, in this example being in respect of an enterprise model, representative of the processes and activities performed by the enterprise system 140. The logical process model information 310 includes a logical process model 312 comprising structured data defining the processes constituting the business model, and showing relationships between respective process activities constituting the respective processes. In the current example, the logical process model 312 may be a logical process model defining the sequence of process activities abstractly, without defining relationship of the activities or processes to process elements associated with operationalization of the process, which may be provided by the dependency information 302. Enterprise elements or process elements modeled in such an enterprise model may include a value chain, business domains/sub-domains, business functions/sub-functions, processes, activities, information/data, IT applications, IT hardware, human resources, physical assets, and any other elements relevant to the enterprise.

The logical process model 312 references failure definitions 314 which may include service-level agreements 316 and key performance indicators 318. The failure definitions 314, SLAs 316, and KPIs 318 may be user-specified.

It will be appreciated that the logical process model information 310 and the dependency information 302 together provide process model information (or enterprise model information) defining a process architecture for the enterprise system 140, the process architecture comprising, on the one hand, the processes and activities defined by the logical process model 312, and, on the other hand, information on the operationalization of the processes and activities as defined by the dependency information 302.

Thus, the databases 126 may include dependency information 302 in process dependency repositories, the dependency information 302 comprising structured information regarding dependencies of respective processes and/or process activities of the enterprise model. The dependency information 302 includes IT system dependency information 304 that comprises information regarding process dependency on IT system elements of the enterprise system 140. The IT system dependency information 304 may thus include information regarding dependency of processes or activities on software such as process applications 146, 148, as well as dependency on IT infrastructure. In this regard, IT infrastructure refers to the configuration and arrangement of hardware forming part of the enterprise system 140. IT infrastructure information may thus include the properties, statuses, configuration, and relationships of hardware components such as particular servers, machines, and/or interfaces in the enterprise system 140. The term IT system includes the IT infrastructure and software or process applications 146, 148 supported by the IT infrastructure. The IT system dependency information 304 also includes datastore dependency information indicative of relationships between respective activities and datastores which are accessed in performance of the respective activities. As used herein, datastore dependency is distinct from data dependency. Datastore dependency is concerned with whether or not a particular datastore is available and/or operational, while data dependency is concerned with the availability and/or quality of data in an operational and available datastore. In other words, data dependency relates to the availability and/or quality of data in a datastore, assuming that the datastore is fully operational. Thus, for example, the failure of a server on which a datastore is hosted, or the failure of a data link to a datastore, will be related to datastore dependency. In contrast, for example, the absence of particular required records or data fields in a datastore, even when the datastore is fully operational; the quality of data in the datastore; the failure of data transfers into the datastore; or the failure of data synchronization between the datastore and another datastore will be related to data dependency.

The IT system dependency information 304 enables the generation of an interactive GUI displaying those process applications and process servers on which a selected process or process activity is dependent.

The dependency information 302 may further include human resources dependency information 306 in which is stored structured information regarding the dependency of respective processes or process activities on particular human resource components, such as people or personnel. The HR dependency information 306 may for example specify the job role or personnel department responsible for the performance of a particular process activity.

Physical infrastructure dependency information 307 may also be included in the dependency information 302 to indicate the dependency of respective process activities on physical infrastructure components. Such physical infrastructure components may include, for example, vehicles, machinery, supply-chain elements, buildings, and the like.

The dependency information 302 also includes data dependency information 308. The data dependency information 308 may include data quality dependency information 309 and data availability dependency information 311. The data quality dependency information 309 indicates dependency of process activities on quality of data in respective datastores, such as the databases 150 and 152 (FIG. 1). The data quality dependency information 309 may thus, e.g., indicate dependency of particular process activities on the age or staleness of data in associated datastores, completeness, precision level and the referential integrity or data integrity of data in associated datastores, or the like.

The data availability dependency information 311 is indicative of dependency of process activities on the availability of data in the one or more datastores which may be accessed in execution of respective activities. The data availability dependency information 311 may, for instance, include data flow dependency information 313 indicative of dependency of one or more direct datastores (that is, datastores which may be directly accessed during performance of the associated process activities) on associated process elements for data flow into the respective datastores. The data flow dependency information 313 may therefore be indicative of process elements contributing to the flow of data into one or more direct datastores, as well as dependency of respective process activities on the flow of data into the respective direct datastores. The data flow dependency information 313 may be with respect to process elements which contribute directly or indirectly to data flow into respective direct datastores, and may thus include information regarding data flow into indirect datastores. In other words, the data flow dependency information 313 may comprise information regarding process elements, such as process applications, process servers, personnel, and/or business processes or activities which contribute to the flow of data into respective datastores accessed during performance of associated activities/processes, and upon which such activities/processes are therefore dependent for the availability and/or quality of data. It is to be appreciated that explicit dependencies or datastore dependencies are defined as part of the IT system dependency information 304, while data flow dependencies are defined as part of the information 308. As used herein, “explicit dependency,” or “direct dependency” of an activity means that an associated process element contributes directly to performance of the activity, and is to be distinguished from data dependency. Consider, for example, an activity that is performed by an application which accesses a particular datastore during execution of the application, while data in the particular datastore is, e.g., periodically synchronized with a master datastore. In such case, the activity will have a direct or explicit dependency on the particular datastore which is accessed during execution of the application, and will be data dependent on the master datastore, in particular being data flow dependent on the master datastore. The term “data dependent” means that a particular process element contributes to the availability and/or quality of data in general or of a particular data element, such as an entity attribute, in a datastore, and that failure or absence of the particular process element may affect the availability and/or quality of data in the datastore. Likewise, the term “data flow dependent” means that a particular process element contributes to the flow of data into a particular datastore, and that failure or absence of the particular process element may affect the flow of data into the particular datastore. In this regard a process element may include, for example, a data source, an IT infrastructure component, a process application, a process event, a human resources component, or the like. The term “datastore” means any repository or memory on which data is stored, and may include internal memory forming part of a device contributing to performance of activity, as well as external databases.

It is to be appreciated that, in the above example, the activity will not be datastore dependent on the master datastore, so that the relationship between the activity or application and the master datastore will not form part of datastore dependency information as a subset of IT system dependency information 304 with respect to the activity, but will be included in data dependency information 308 with respect to the activity. In particular, the relationship between the activity or application and the master datastore may in such case form part of the data flow dependency information 313, being a subset of the data availability dependency information 311.

The provision of the data availability dependency information 311 permits the identification or prediction of failure or unavailability of a particular IT infrastructure element or process application not only on processes or process activities which are directly dependent on the failed IT infrastructure element or process application, but also on processes or activities which are not directly dependent on the failed element or application, but which are dependent on the failed element or application for the flow of data into datastores which are accessed directly during execution of the process or activity.

The data availability dependency information 311 may further include data element dependency information 315, which comprises information regarding dependency of respective activities on particular data elements in the one or more datastores which may be accessed in execution of respective activities. Such data element dependency information 315 may thus, for example, indicate particular data items, such as entity attributes, on which respective activities are dependent. The data element dependency information 315 may be in respect of dependency on a particular attribute for execution of a process activity in general. In an invoicing activity, for example, data element dependency information 315 may indicate that the process activity is dependent on the presence or availability in the associated datastore of a value for the client account code attribute.

Root cause analysis for a data problem encountered during the performance of a process activity may be performed based on data dependency information contained in dependency information 302 forming part of the process model information. The data dependency information 308 may be analyzed to identify which of the listed data dependencies was reported as the encountered problem. Once a match is found, root cause analysis may be performed based on the data flow dependency information 313 to identify the process elements whose failure may have caused the data problem.

It will be appreciated that the logical process model information 310 and the dependency information 302 together to provide process model information (or enterprise model information) defining a process architecture for the enterprise system 140, the process architecture comprising, on the one hand, the processes and activities defined by the logical process model 312, and, on the other hand, information on the operationalization of the processes and activities as defined by the dependency information 302.

The process management system 102 further comprises historical data 320 indicative of past performance of processes defined in the logical process model 312, as well as being indicative of the latest state of process elements and data in respective datastores. The historical data 320 may preferably be gathered in real-time or near real-time, optionally being gathered upon performance of the respective processes or process activities. Instead, or in combination, the historical data 320 may be gathered at predefined times or intervals. Historical data 320 may include applications failure history 322 indicative of failure of process applications 146, 148, as well as IT infrastructure failure history 324 indicative of past failure of IT infrastructure elements, such as process servers 142, 144. The historical data 320 may further include physical infrastructure failure history 327 with respect to failure of physical infrastructure elements, such as vehicles, machinery, and the like. Human resource performance history 323 may also form part of the historical data 320 to provide information regarding historical performance of particular human resource components such as personnel, personnel departments, operational units, and the like. The historical data 320 may also include data flow history 332, which comprises historical information with respect to the flow of data elements into respective datastores forming part of the enterprise system 140. The data flow history 332 may, for example, include process activity logs for updating and/or synchronizing activities performed by the updating application 168 and the synchronizing application 164, respectively, of FIG. 1.

As illustrated in FIG. 3, the process management application(s) 120 may access the logical process model information 310, the dependency information 302, the historical data 320, the EDM 340, and the data issue repository 350 in order to perform the various functionalities as discussed herein.

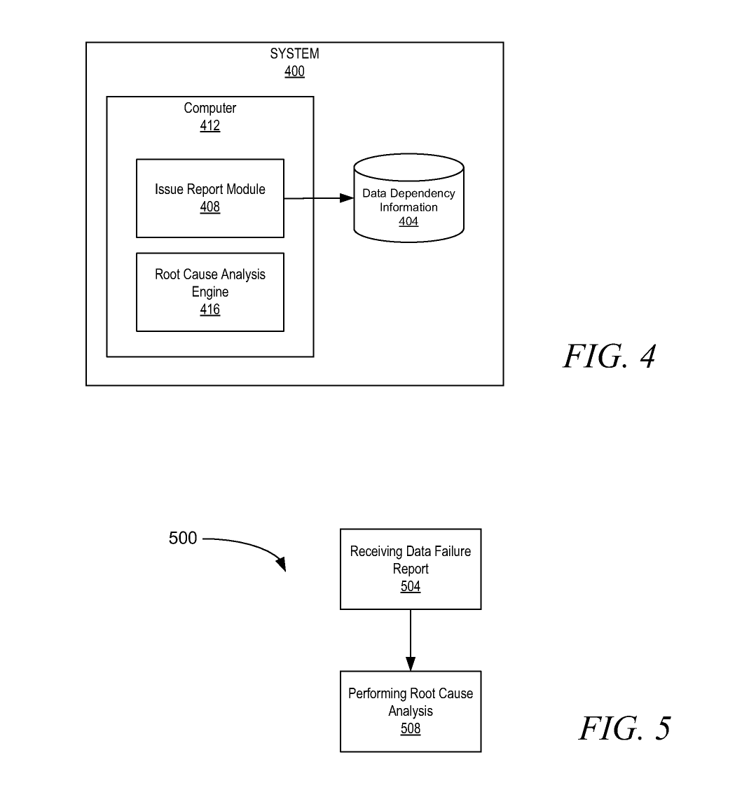

FIG. 4 is a high-level block diagram depicting another example configuration of the process management system, in particular being a system 400 for automated root cause analysis. The system 400 may include a computer 412 that may include a root cause analysis engine 416 to perform automated root cause analysis. The system 400 may further include an issue report module 408 to receive or generate a data problem report indicative of the occurrence of a data problem or data failure during the performance of a process managed by the system 400. Such a data problem report indicates the occurrence of a data problem during the performance of the process owing to unavailability and/or incorrectness of a problematic data item. The data problem report may include at least one descriptor to identify the problematic data item, and may additionally include an activity descriptor identifying the process activity in which the data problem was encountered. The system 400 further includes at least one memory or database on which is stored data dependency information 404. The data dependency information 404 may be similar or analogous to the data dependency information 308 described with reference to FIG. 3 above and may comprise, with respect to each of a plurality of process activities, information on respective data dependencies including data flow dependencies that identify the process elements and/or process activities which contribute to the provisioning of data items that are instances of the respective entity attributes. The root cause analysis engine 416 may perform its automated root cause analysis based at least in part on the data dependency information 404 and on one or more descriptors of the problematic data item contained in the data problem report, to identify at least one potential cause for the data problem indicated by the data problem report. Although the issue report module 408 and the root cause analysis engine 416 are shown, in FIG. 4, to be provided by a common computer 412, these features may be provided separately, in other embodiments.

### Flowcharts

An exemplary method will now be described with reference to FIG. 5, which depicts a high-level flow chart for a method 500 of facilitating root cause analysis of a data problem in a process. The method 500 comprises receiving a data problem report, at operation 504, and performing automated root cause analysis, at operation 508, based on the data problem report. The root cause analysis, at operation 508, may comprise identifying at least one potential cause of the data problem indicated by the data problem report, for example identifying a set of processes or activities that provide a problematic data item to a particular datastore associated with the data problem. The data problem report may indicate a data problem comprising unavailability and/or incorrectness of a problematic data item, and may include at least one descriptor to identify the problematic data item. The root cause analysis may be performed with reference to one or more descriptors provided by the data problem report. The root cause analysis may be performed based on data dependency information similar or analogous to the data dependency information 308 described with reference to FIG. 3. Such data dependency information may comprise, with respect to each of a plurality of process activities, information on respective data dependencies including data flow dependencies that identify the process elements and/or process activities which contribute to the provisioning of a corresponding database or datastore of data items which are instances of respective entity attributes associated with the process activity.

FIG. 6 shows a flowchart of a further example embodiment of a method 600 of facilitating automated root cause analysis of a process failure. The example embodiment of FIG. 6 will be described as being performed in the system client-server system 100 of FIG. 1, using the process management application(s) 120 (FIG. 2) and the data structures described with reference to FIG. 3.

The method 600 commences when an incident ticket is received at operation 604. Such an incident ticket is often filed by a user (but may also be automatically generated by a program) in response to a process failure manifested by the malperformance of a process or process activity. As used herein, malperformance of a process or process activity may include failure to perform the process or activity, as well as incorrect performance of the process or activity. Thus, for example, a client of a freight forwarding service provided by the enterprise system 140 may file an incident ticket, at operation 604, when the FFS application 148 (FIG. 1) fails to generate a shipping notification addressed to the appropriate customer in response to shipping a specific order or consignment. The incident ticket may be filed by a customer who fails to receive the notification, or may be filed by a user within an organization performing the process.

The incident ticket may be analyzed, at operation 608, to identify a problematic data item associated with the process failure. Such analysis may be performed by a support analyst, who may identify that the process failure (manifested, for example, in the non-transmittal of a shipping notice) is caused by a data problem comprising an incorrect or missing data item. For example, the support analyst may identify that the failure to send the shipping notice, which is the subject of the incident ticket, was caused by failure of an account reference lookup by the FFS application 148 in the GRDS 152 (both of FIG. 1). In the present example, the support analyst may identify that an attribute representing an account reference for a customer associated with the particular order whose shipment notice failed is missing in the GRDS 152.

The support analyst may thereafter enhance the incident ticket with one or more descriptors at operation 612 to generate a data problem report upon which automated root cause analysis may be based. The support analyst may, for example, associate with the data problem report an entity instance identifier that indicates a particular entity associated with the problematic data item, in this example being “Customer X.” An attribute identifier may further be included in the data problem report to indicate a particular attribute of which the problematic data item is an instance. Thus, in the present example, the data problem report may include an attribute identifier such as “customer.attr_account_ref.” The support analyst may yet further attach to the data problem report a failure type identifier to identify an associated type of data problem. In the current example, the failure type identifier may be “Missing Value.” The data problem report may also include an activity descriptor identifying a particular process activity in which the problematic data item resides or should have resided. The data problem report of the present example may thus include an activity identifier or descriptor indicating “shipment notification”.

The enhancements to the incident ticket, at operation 612, to generate the data problem report, which includes the various descriptors, may be performed by the support analyst by means of a GUI generated by the GUI module 200 and/or the issue report module 204 (both of FIG. 2). Input of the various descriptors by the support analyst may be by selection from respective lists of predetermined options, which may, for example, be provided by means of drop-down menus. The GUI module 200 may thus present the support analyst with a drop-down menu for each type of descriptor. The particular options provided by such drop-down menus may further be dynamically context-sensitive, so that selection of a particular descriptor for one descriptor type may determine the available options for another descriptor type to descriptors associated in the EDM 340 with the selected descriptor. For example, when the user clicks on a drop-down menu for the selection of an entity descriptor and selects the descriptor “e_customer,” the options presented in a drop-down menu for an attribute identifier may be automatically limited to those attributes included in the attribute list 344 of the EDM 340 and associated in the EDM 340 with the entity identifier “e_customer.” The enhancement of the incident ticket by the association of descriptor(s) with the ticket, at operation 612, may be limited to the selection of options from such predetermined lists, and may prohibit the entry of free text descriptors, thereby ensuring consistency in the use of the respective descriptors. The drop-down menus described above may be made optional, or may be completely hidden, for the user reporting the incident ticket, at operation 604, while being mandatory for the support analyst in enhancing the ticket, at operation 612.

Enhancement of the incident ticket may, however, include the provision of a suggested value for the problematic data item. Thus, for example, in instances where the data problem is caused by an incorrect value for a particular instance of an attribute, and where the support analyst (optionally, with guidance from the user) is aware of the correct value, the support analyst may enhance the ticket, at operation 612, by entering the correct value in the data problem report. Such a suggested value may be used in correction of the data problem, for example in the manual fixing of the problematic data item, at operation 640, as is described in greater detail below.

The issue report module 204 may enforce enhancement of the incident ticket with at least one descriptor by not allowing closing and lodging of the data problem report without user selection of at least one descriptor. In some embodiments, completion of the data problem report may be dependent on at least one mandatory descriptor, for example requiring the selection of an attribute identifier.

After the data problem report, also referred to herein as the enhanced incident ticket, is closed, the data issue query module 209 may automatically interrogate the data issue repository 350 to identify similar earlier data problems, at decision operation 616. To this end, the data issue query module 209 may compare the descriptors included in the data problem report to data item descriptors 358 in the data issue repository 350 to identify potentially matching incident records 352. If a similar earlier incident is identified, at decision operation 616, the method 600 proceeds to decision operation 636, as described further below.

If, however, no similar earlier incidents are identified at decision operation 616, automated root cause analysis is performed at operation 620. In this example, automated root cause analysis comprises automated identification of potential causes of the data problem. Identification of potential causes of the data problem may comprise identification of a set or listing of processes, process activities, and/or process elements which contribute to providing the problematic data item to the relevant datastore. In the present example, the root cause analysis provides a listing limited to potential problematic activities, being process activities that contribute to the providing of the problematic data item for shipment notifications that are data dependent on data items in GRDS 152. In other examples, however, the root cause analysis results may also include process elements, such as datastores, human resource components, IT hardware components, IT software components, and the like.

The root cause analysis may comprise extracting from the data flow dependency information 313 a listing of the process activities associated with the particular entity and attribute indicated by the data problem report. The example data problem report, which reports a data problem owing to the absence from the GRDS 152 of the entity attribute “customer.attr_account_ref”, may therefore comprise a listing of process activities that includes an updating activity performed by the updating application 168, and a synchronizing activity performed by the synchronizing application 164. It will be seen that the data flow dependency information 313 includes not only process elements and/or activities which contribute directly to the provisioning of the relevant datastore, but also process elements and/or activities which contribute indirectly to providing the associated data item to the datastore. For example, the customer master datastore 162 and the synchronizing application 164, together with its associated synchronizing activity, do not directly deliver an account reference attribute to the GRDS 152, but contribute indirectly thereto by their involvement in the provision of the account reference attribute to the CRM database 160 by synchronization between the CRM database 160 and the customer master datastore 162.

The results of the root cause analysis is thereafter automatically assessed, at decision operation 624, to determine whether or not the listing of potential problematic activities include more than one activity. If the activity count equals one, then the problematic process activity is recorded, at operation 632. If, however, the activity count is greater than one, the support analysts may analyze the data problem report and the RCA results, at operation 628, to identify and record a particular one of the process activities included in the RCA results which is the cause of the data problem, i.e., which is the problematic activity. In cases where none of the potential problematic activities suggested in the RCA results is the actual root cause of the data problem, the support analyst may analyze whether or not any of the existing processes or activities need to be enhanced, and whether or not new processes and/or activities need to be introduced to avoid similar data problems in future.

It is thereafter considered, at decision operation 636, whether or not the problematic activity is automated. If the problematic activity is not an automated activity, then the problematic data item may be fixed manually, at operation 640. If, for example, the problematic process activity is a manual data input activity in which data is provided by a user directly to the GRDS 152, the problematic data item having been inputted incorrectly or having been omitted from input, then the analyst may fix the problematic data item, at operation 640, by manual input or correction of the relevant data item into the GRDS 152.

If, however, the problematic activity is determined at decision operation 636 to be an automated activity, then process logs for the problematic activity may be parsed, at operation 644, to identify an exception that may indicate malperformance of an instance of the problematic activity potentially causing the data problem, such as a database exception indicated by an exception code in the corresponding process audit log. In the present example, parsing of process logs for the updating activity performed by the updating application 168 may, for example, identify an exception with respect to the updating of the account reference attribute of the customer to whom shipping notification was not sent. The correct attribute value (e.g., the value for “attr_account_ref”) may be retrieved from the logs and the problematic activity may be re-triggered, at operation 648. Re-triggering of the problematic activity may, in some examples, be performed automatically, while, in other examples, the re-triggering of the problematic activity may be an optional operation. Such re-triggering of the problematic activity achieves correct performance of the activity whose malperformance caused the data problem, and therefore promotes the presence in the GRDS 152 of data items provided by a malperformed or failed instance of the problematic activity.

A remediation script, or multiple remediation scripts, may be executed, at operation 652, to fix the process failure caused by the data problem. In the present example embodiment, the remediation script may effect the transmission of the shipping notification that was not sent owing to the incorrect account reference attribute in the GRDS 152. The remediation script(s) may be generated by the analyst. Instead, if a matching incident record 352 in the data issue repository 350 was identified, at operation 616, then the remediation script 356 corresponding to the matching incident record 352 may be retrieved from the data issue repository 350 and may be executed to remedy the process failure.

The data issue repository 350 is thereafter updated, at operation 656, to reflect the reported incident. An appropriate incident record 352 may thus be lodged in the data issue repository 350, together with corresponding RCA results 354, remediation script(s) 356, and data item descriptors 358 included in the data problem report.

Finally, the user may be notified, at 660, that the data problem reported in the incident ticket or data problem report has been fixed.

The example method 600 described above thus facilitates and supports the fixing or remediation of not only a particular data problem, but also facilitates the fixing or remediation of an underlying process or activity that might have caused the particular data problem or data failure. In some embodiments, a data issue may be automatically fixed. The identification of a root cause of the data problem is facilitated by automated root cause analysis, which provides the support analyst with a list of potential problematic activities. Integration between the EDM 340 and the issue report module 204 promotes the reporting of data problems in a structured form that enforces terminological consistency.

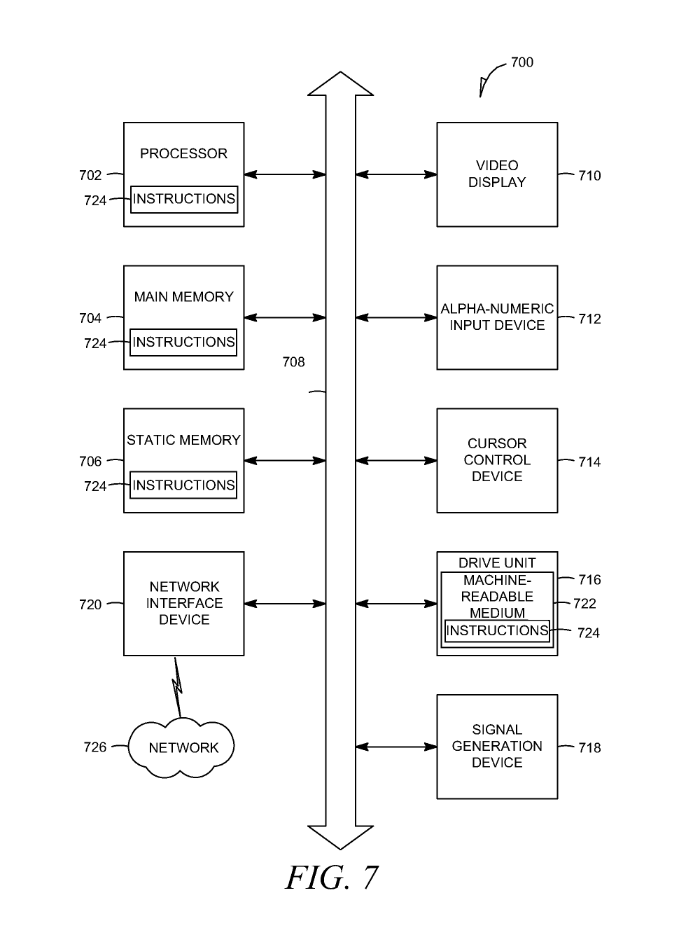

FIG. 7 shows a diagrammatic representation of machine in the example form of a computer system 700 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions 724 (e.g., software) embodying any one or more of the methodologies or functions described herein. The software or instructions 724 may also reside, completely or at least partially, within the main memory 704 and/or within the processor 702 during execution thereof by the computer system 700, the main memory 704 and the processor 702 also constituting machine-readable media.

The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions 724. The term “machine-readable medium” shall also be taken to include any medium that is capable of storing, encoding or carrying a set of instructions for execution by the machine and that cause the machine to perform any one or more of the methodologies described herein. The term “machine-readable medium” shall accordingly be taken to include, but not be limited to, solid-state memories, optical and magnetic media, and carrier wave signals.

Thus, a method and system to perform analysis of a process supported by a process system have been described. Although the system and method have been described with reference to specific example embodiments, it will be evident that various modifications and changes may be made to these embodiments without departing from the broader spirit and scope of method and/or system. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
an issue report module to receive or generate a data problem report indicative of occurrence of a data problem during performance of a process, the data problem comprising unavailability or incorrectness of a problematic data item, the data problem report including at least one descriptor to identify the problematic data item; and
a computer including a root cause analysis engine to perform automated root cause analysis based at least in part on the at least one descriptor of the problematic data item, to identify at least one potential cause of the data problem indicated by the data problem report.

2. The system of claim 1, further comprising at least one memory having stored thereon data dependency information which comprises, with respect to each of a plurality of entity attributes, information regarding process elements and/or process activities which contribute to provisioning of data items which are instances of the respective entity attributes, the root cause analysis engine to perform the automated root cause analysis based at least in part on the data dependency information.

3. The system of claim 2, wherein the at least one descriptor of the problematic data item comprises at least one of: an entity instance identifier to identify a particular entity associated with the problematic data item, an attribute identifier to identify an entity attribute of which the problematic data item is an instance, and a failure type identifier to identify an associated type of data problem.

4. The system of claim 2, wherein the data problem report includes an entity instance identifier to identify a particular entity associated with the problematic data item, and an attribute identifier to identify an entity attribute of which the problematic data item is an instance.

5. The system of claim 2, wherein the data problem report further includes at least one activity descriptor identifying a particular process activity in which the data problem was encountered.

6. The system of claim 5, wherein the data dependency information comprise, with respect to each of a plurality of process activities, data dependencies for data items associated with the respective process activities, the root cause analysis engine being configured to perform the automated root cause analysis based at least in part on the at least one activity descriptor.

7. The system of claim 1, wherein the data problem report includes a suggested value for the problematic data item.

8. The system of claim 2, wherein the root cause analysis engine is to produce a listing of process activities and/or process elements which contribute, based on the data dependency information, to provisioning of the problematic data item.

9. The system of claim 2, wherein the issue report module is to require, in response to entry of information regarding the data problem, input with respect to the at least one descriptor.

10. The system of claim 9, wherein the issue report module is to require input with respect to the a minimum required descriptors by providing a predetermined list of options from which a particular option is to be selected, and receiving input indicating selection of the particular option.

11. The system of claim 10, wherein the issue report module is to generate the predetermined list of options with reference to an enterprise data model which contains information regarding predefined descriptors for identifying the problematic data item.

12. The system of claim 10, wherein the issue report module is to generate the predetermined list of options with reference to, at least, process management information which contains information regarding predefined activity descriptors to identify a particular process activity in which the data problem was encountered.

13. The system of claim 1, further comprising:
a data issue repository comprising information regarding earlier data problem reports and respective results of root cause analyses previously performed with respect to the earlier data problem reports; and
a data issue query module to query the data issue repository upon receiving the data problem report, to identify similar earlier data problems, and in response to identifying a similar earlier data problem report in the data issue repository, providing as a result of the root cause analysis with respect to the data problem report the results of root cause analyses previously performed with respect to the similar earlier data problem report.

14. The system of claim 8, further comprising:
a parsing module to parse process logs of an automated process activity identified in the listing, to identify an exception indicating an instance of malperformance of the automated process activity; and
a re-triggering module to re-trigger execution of the automated process activity.

15. The system of claim 14, further comprising a remediation module to execute a remediation script to remediate a process failure resulting from the data problem indicated in the data problem report.

16. A computer-implemented method comprising:
receiving a data problem report indicative of occurrence of a data problem during performance of a process, the data problem comprising unavailability or incorrectness of a problematic data item, the data problem report including at least one descriptor to identify the problematic data item; and
performing automated root cause analysis to identify at least one potential cause of the data problem indicated by the data problem report, the root cause analysis being based at least in part on the at least one descriptor of the problematic data item.

17. The computer-implemented method of claim 16, wherein the root cause analysis is based at least in part on data dependency information which comprises, for each of a plurality of entity attributes, information regarding process elements and/or process activities which contribute to provisioning of data items which are instances of the respective entity attributes the at least one descriptor of the problematic data item comprises at least one of: an entity instance identifier to identify a particular entity associated with the problematic data item, an attribute identifier to identify an entity attribute of which the problematic data item is an instance, and a failure type identifier to identify an associated type of data problem.

18. The computer-implemented method of claim 17, wherein the at least one descriptor of the problematic data item comprises at least one of: an entity instance identifier to identify a particular entity associated with the problematic data item, an attribute identifier to identify an entity attribute of which the problematic data item is an instance, and a failure type identifier to identify an associated type of data problem.

19. The computer-implemented method of claim 17, wherein the data problem report further includes at least one activity descriptor identifying a particular process activity in which the data problem was encountered.

20. The computer-implemented method of claim 19, wherein the data dependency information comprise, with respect to each of a plurality of process activities, data dependencies for data items associated with the respective process activities, the root cause analysis engine being configured to perform the automated root cause analysis based at least in part on the at least one activity descriptor.

21. The computer-implemented method of claim 16, wherein the data problem report includes a suggested value for the problematic data item.

22. The computer-implemented method of claim 17, further comprising producing, as a result of the automated root cause analysis, a listing of process activities and/or process elements which contribute, based on the data dependency information, to provisioning of the problematic data item.

23. The computer-implemented method of claim 17, further comprising, in response to entry of information regarding the data problem, requiring input with respect to the at least one descriptor of the problematic data item and at least one activity descriptor identifying a particular process activity in which the data problem was encountered, and associating the at least one descriptor of the problematic data item and the at least one activity descriptor with the entered information regarding the data problem, to generate the data problem report.

24. The computer-implemented method of claim 23, wherein requiring input with respect to the at least one descriptor of the problematic data item and the at least one descriptor identifying the process activity in which the data problem was encountered comprises providing at least one predetermined list of options from which a particular option is to be selected, and receiving input indicating selection of the particular option.

25. The computer-implemented method of claim 24, wherein a predetermined list of options for the at least one descriptor of the problematic data item is generated with reference to an enterprise data model which contains information regarding predefined descriptors.

26. The computer implemented method of claim 22, wherein a predetermined list of options for the at least one activity descriptor is generated with reference to process management information which contains information regarding predefined activity descriptors.

27. The computer-implemented method of claim 16, further comprising:
a upon receiving the data problem report, querying a data issue repository based at least in part on the at least one descriptor of the problematic data item, to identify similar earlier data problems, the data issue repository comprising a record of earlier data problem reports together with respective results of root cause analyses previously performed with respect to the earlier data problem reports; and
in response to identifying a similar earlier data problem report in the data issue repository, providing as a result of the root cause analysis with respect to the data problem report the results of root cause analyses previously performed with respect to the similar earlier data problem report.

28. The computer-implemented method of claim 27, further comprising adding to the data issue repository information regarding the data problem indicated by the data problem report, together with results of the associated root cause analysis.

29. The computer-implemented method of claim 22, further comprising:
parsing process logs of an automated process activity identified in the listing, to identify an exception indicating an instance of malperformance of the activity; and
re-triggering execution of the activity.

30. The computer-implemented method of claim 29, further comprising executing a remediation script to remediate a process failure resulting from the data problem indicated in the data problem report.

31. A non-transitory machine-readable storage medium storing instructions which, when performed by a machine, cause the machine to:
receive a data problem report indicative of occurrence of a data problem during performance of a process, the data problem comprising unavailability or incorrectness of a problematic data item, the data problem report including at least one descriptor to identify the problematic data item; and
perform automated root cause analysis to identify at least one potential cause of the data problem indicated by the data problem report, the root cause analysis being based at least in part on the at least one descriptor of the problematic data item.

32. A system comprising:
means for receiving a data problem report indicative of occurrence of a data problem during performance of a process, the data problem comprising unavailability or incorrectness of a problematic data item, the data problem report including at least one descriptor to identify the problematic data item; and
means for performing automated root cause analysis to identify at least one potential cause of the data problem indicated by the data problem report, the root cause analysis being based at least in part on the at least one descriptor of the problematic data item.
